(19) United States
(12) Patent Application Publication
(10) Pub. No.: US 2011/0310430 A1
(43) Pub. Date: Dec. 22, 2011

(54) DEVICE DETECTING NON-RETRIEVED FORMS IN PRINTER

(76) Inventor: Leeming Niu, Fujian (CN)

(21) Appl. No.: 13/130,407

(22) PCT Filed: Mar. 6, 2009
(86) PCT No.: PCT/CN2009/070668

§ 371 Date: May 20, 2011

(51) Int. Cl. G06F 3/12

(52) U.S. Cl. 358/1.15

(57) ABSTRACT

Disclosed is a device to detect in a printer the presence of non-retrieved printed receipts or order bills, which includes an infrared detection lamp and an alert circuit. The infrared detection lamp includes an emitting lamp and a receiving lamp. Both are provided at a paper discharge port of a printer and wherein a line perpendicular to the paper discharge port bisects the angle formed by the light rays from the emitting lamp and the receiving lamp. The receiving lamp is connected to the alert circuit and activates the alert circuit when it receives a signal from the emitting lamp. The device can emit a notification signal when a printed item is not retrieved, thus ensuring speed and continuity in kitchen operations, improving work efficiency, and shortening customer wait time.

### BACKGROUND OF THE INVENTION

1. Field of the Invention

The present invention relates to a detection device of a printer, and more particularly to a device to detect non-retrieved order bills in the printer.

2. Description of the Prior Art

Nowadays, there is a distance from the lobby to the kitchen of a hotel, so a food order apparatus including a keyboard and a printer is provided. The keyboard and the printer are respectively provided at the lobby and the kitchen and connected by a network. When the customer wants to order food, the attendant in the lobby will input the items of the order, and then the order bill will be printed by the connected printer and sent out from the paper discharge port of the printer. The cutter is started to cut the order bill, and the cook takes the order bill to proceed cooking. There are some shortcomings existed in the apparatus.

When the printer prints the order bill, the printer will have a sound and the cook will come to take the order bill. However, there is a loud noise in the kitchen. The sound of the printer cannot be heard sometimes. This causes a delay to cook the food, which will influence the services. In order not to miss the order bill, it is required to check whether there is an order bill. This influences the work efficiency. In particularly, a person to check the order bills will consume time. Accordingly, the inventor of the present invention has devoted himself based on his many years of practical experiences to solve this problem.

### SUMMARY OF THE INVENTION

The primary object of the present invention is to provide a device to detect non-retrieved forms in a printer. When an order bill is not taken, the device will send an alarm, ensuring speed and continuity in kitchen operations, improving work efficiency, and shortening customer wait time.

In order to achieve the aforesaid object, there is provided a device to detect non-retrieved forms in a printer. The device comprises an infrared detection lamp and an alert circuit. The infrared detection lamp and the alert circuit are disposed at a paper discharge port of the printer. A line perpendicular to the paper discharge port is a bisector of an inclined angle formed by light rays from the emitting lamp and the receiving lamp. The receiving lamp is connected with the alert circuit and conducts the alert circuit when receiving a signal from the emitting lamp.

Preferably, the infrared detection lamp is disposed on a bracket.

Preferably, the alert circuit comprises a buzzer.

Preferably, the alert circuit comprises an alarm lamp.

Accordingly, the present invention provided the infrared detection lamp disposed at the paper discharge port. When there is an order bill at the paper discharge port, the infrared ray from the emitting lamp will be on the order bill and then reflected to the receiving lamp. The receiving lamp activates the alert circuit to sound and light the alarm for reminding the workers in the kitchen to take the order bill. The present invention shortens the time to wait and improves work efficiency and is convenient to use, without taking time to check the order bills.

### BRIEF DESCRIPTION OF THE DRAWINGS

FIG. 1 is a front view according to a preferred embodiment of the present invention;

FIG. 2 is a top view according to the preferred embodiment of the present invention;

FIG. 3 is a sectional view taken along line A-A of FIG. 2;

FIG. 4 is an exploded view according to the preferred embodiment of the present invention, and

FIG. 5 is a schematic view showing the alert circuit of the present invention.

### DETAILED DESCRIPTION OF THE PREFERRED EMBODIMENTS

Embodiments of the present invention will now be described, by way of example only, with reference to the accompanying drawings.

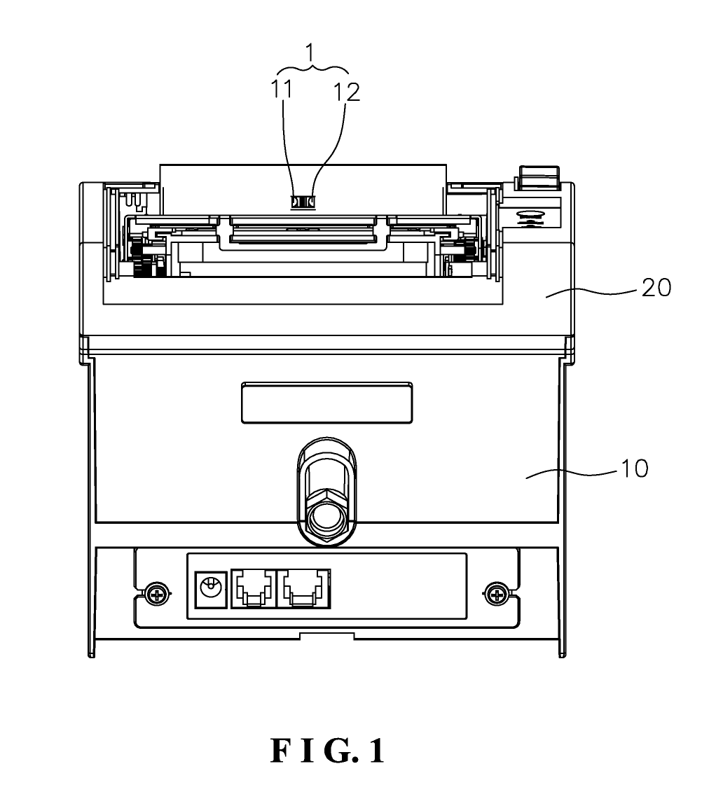

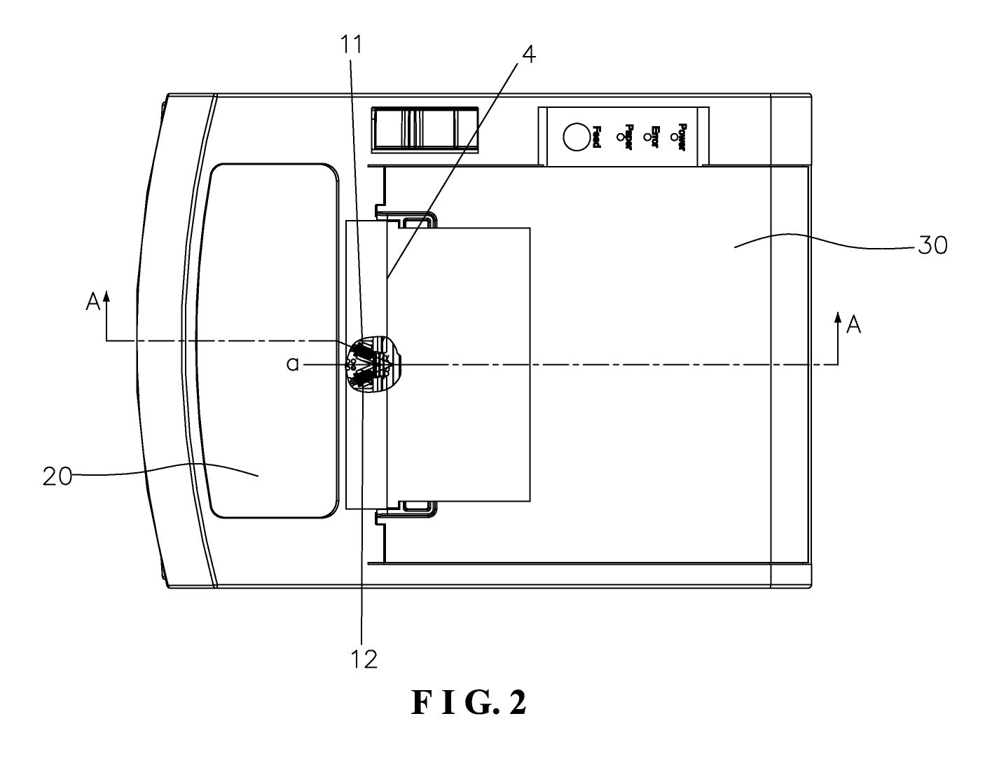

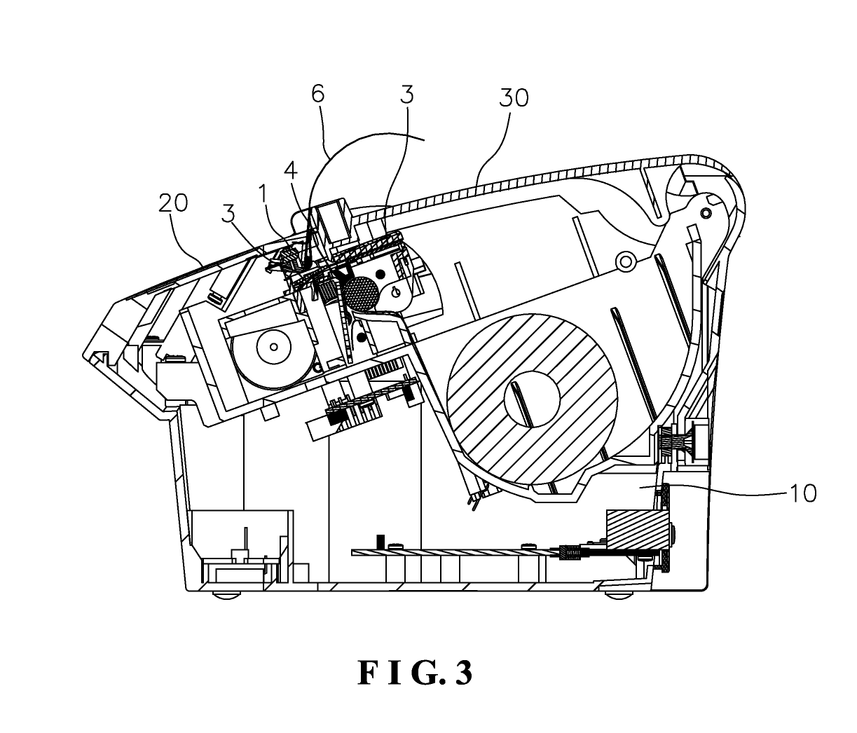

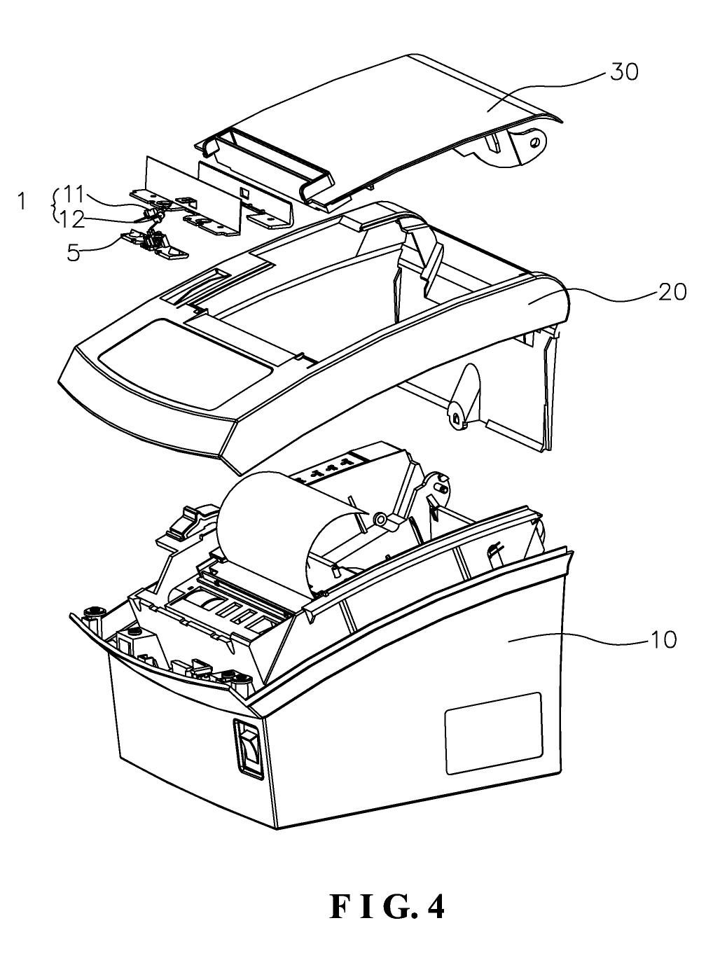

As shown in FIG. 1 and FIG. 2, a device to detect non-retrieved forms in printer as shown in FIG. 4. The printer comprises a main body 10, an upper casing 20, and a top cover 30. The upper casing 20 is fitted on the main body 10. An accommodation room is defined between the main body 10 and the upper casing 20. A roll of paper is provided in the accommodation room. A cutter 3 is provided in the accommodation room, as shown in FIG. 3. The top cover 30 is fitted on the upper casing 20 and has a paper discharge port 4. The roll of paper can be rotated and extended for printing. The paper is cut by the cutter 3 and sent out from the paper discharge port 4. In this embodiment, the device further comprises an infrared detection lamp 1 and an alert circuit 2.

The infrared detection lamp 1 comprises an emitting lamp 11 and a receiving lamp 12 which are disposed on a bracket 5. The bracket 5 is located at the paper discharge port 4 above the cutter 3. Referring to FIG. 3 and FIG. 4, the emitting lamp 11 and the receiving lamp 12 are disposed at two sides of a line a which is perpendicular to the paper discharge port 4. The light ray emitted from the emitting lamp 11 and the line a define an included angle a. The light ray emitted from the receiving lamp 12 and the line a define an included angleβ. a is equal to β, namely, the line a bisects the angle formed by the light rays from the emitting lamp 11 and the receiving lamp 12. Under the condition that a reflection medium at the acme point of the inclined angle, the signal from the emitting lamp 11 can be received by the receiving lamp 12 to send a trigger signal.

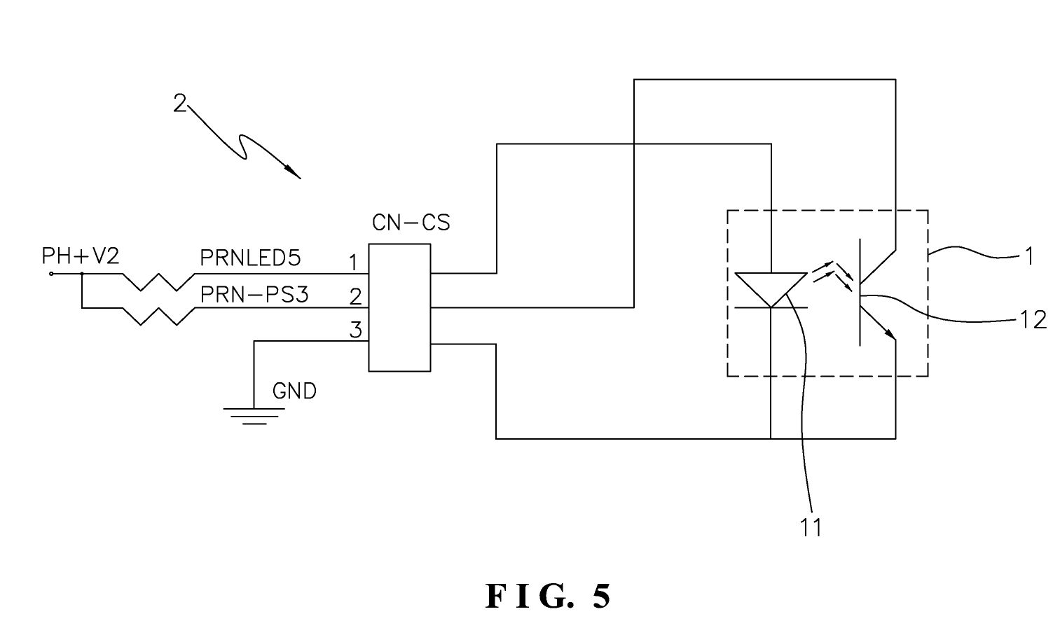

The alert circuit 2 is to send a warning and activated by the signal from the receiving lamp 12. Referring to FIG. 5, in this embodiment, the alert circuit 2 is connected with a buzzer, namely PRN-PR3 in FIG. 5, and an alarm lamp namely, PRNLED 5 in FIG. 5. When the receiving lamp 12 receives an infrared signal from the emitting lamp 11, referring to FIG. 5, the feet 1, 2 of the chip are low lever to conduct the circuit and sound the buzzer and light the alarm light for a sound and light alarm, preventing the workers in the kitchen from not taking the order bills.

In operation, referring to FIG. 3, the attendant in the hall inputs the items chosen by the customer by means of a keyboard, and then the printer prints the order bill 6 which is sent out from the paper discharge port 4. After that, the order bill 6 is cut by the cutter 3. If the order bill 6 is not taken away and the order bill is at the paper discharge port 4, the infrared ray from the emitting lamp 11 will illuminate the order bill 6 and the ray will be reflected to the receiving lamp 12. The receiving lamp 12 sends a trigger signal to conduct the alert circuit 2 to sound the buzzer and to activate the alarm light so as to remind the workers in the kitchen that the order bill has not been taken. Once the order bill 6 is taken away, there is no infrared reflection at the paper discharge port 4 so the alert circuit won't be activated to avoid mistakes.

Accordingly, the feature of the present invention is that the infrared detection lamp 1 is provided at the paper discharge port 4. When there is an order bill 6 at the paper discharge port 4, the infrared ray from the emitting lamp 1 will be on the order bill and then reflected to the receiving lamp 12. The receiving lamp 12 activates the alert circuit 2 to sound and light the alarm for reminding the workers in the kitchen to take the order bill 6. The present invention shortens the time for the customer to wait and improves work efficiency and is convenient to use, without taking time to check the order bills.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A device to detect non-retrieved forms in a printer, the device comprising an infrared detection lamp and an alert circuit which are disposed at a paper discharge port of the printer, a line perpendicular to the paper discharge port bisecting an inclined angle formed by light rays from the emitting lamp and the receiving lamp, the receiving lamp being connected with the alert circuit and conducting the alert circuit when receiving a signal from the emitting lamp.

2. The device as claimed in claim 1, wherein the infrared detection lamp is disposed on a bracket.

3. The device as claimed in claim 1, wherein the alert circuit comprises a buzzer.

4. The device as claimed in claim 1, wherein the alert circuit comprises an alarm lamp.
